(19) United States
(12) Patent Application Publication
(10) Pub. No.: US 2004/0077741 A1
(43) Pub. Date: Apr. 22, 2004

(54) Flame-retardant flexible polyurethane foams with high aging resistance

(75) Inventors: Susanne Knop, Huerth (DE); Elke Huthmacher, Erftstadt (DE); Toni Nettersheim, Euskirchen (DE)

Correspondence Address: Clariant Corporation, Industrial Property Department, 4000 Monroe Road, Charlotte, NC, 28205, US

(73) Assignee: Clariant GmbH

(21) Appl. No.: 10/684,624

(22) Filed: Oct. 14, 2003

(30) Foreign Application Priority Data
Oct. 15, 2002 (DE) 10247974.7

(51) Int. Cl. C08G 18/00

(52) U.S. Cl. 521/155; 521/168

(57) ABSTRACT

The invention relates to flame-retardant flexible polyurethane foams with high aging resistance, which comprise a mixture composed of hydroxyalkyl phosphonates and chlorinated phosphoric esters, and also to a process for preparing these fire-retardant flexible polyurethane foams.

The invention relates to flame-retardant flexible polyurethane foams with high aging resistance, and a process for their production.

Polyurethane foams are plastics used in many sectors, for example furniture, mattresses, transport, construction, and technical insulation applications. To comply with stringent fire-protection requirements such as those demanded for materials used, inter alia, in the interior fitting-out of automobiles, of rail vehicles, or of aircraft, or materials used to insulate buildings, polyurethane foams generally have to be provided with flame retardants. A wide variety of flame retardants are known and are commercially available for this purpose. However, their use is often inhibited by considerable technical usage problems and/or toxicological concerns.

For example, when solid flame retardants are used, e.g. melamine, ammonium polyphosphate, and ammonium sulfate, problems arise with metering techniques and often necessitate modifications to the foaming plants, i.e. complicated changes in design and modifications. Many of the liquid flame retardants used, for example tris(2-chloroethyl)phosphate and tris(2-chloroisopropyl)phosphate, are characterized by a marked tendency toward migration, which limits their usefulness in open-cell flexible polyurethane foam systems for the interior fitting-out of automobiles, in the light of requirements relating to condensable emissions (fogging).

Fogging is the condensation on glass panes, in particular on the windshield, of vaporized volatile constituents from the material used for interior fitting-out of the motor vehicle. A quantitative assessment of this phenomenon may be made in accordance with DIN 75201.

Halogen-free flame-retardant systems are also preferred on grounds of environmental toxicology, and on grounds of improved ancillary properties in the event of a fire, in terms of smoke density and smoke toxicity. Halogen-free flame retardants can also be of particular interest for performance-related reasons. For example, when halogenated flame retardants are used severe corrosion is observed on the plant components used for the flame-lamination of polyurethane foams. This can be attributed to the hydrohalic acid emissions arising during the flame-lamination of halogen-containing polyurethane foams.

Flame-lamination is the term used for a process for bonding of textiles and foams, by using a flame to melt one side of a foam sheet, and then immediately pressing a textile web onto the same.

Because increasing attention is being paid to gaseous emissions (volatile organic compounds=VOC), there is also an increase in requirements for flame retardants which resist migration.

Materials which have high resistance to migration are hydroxy-containing oligomeric phosphoric esters (DE-A 43 42 972) and hydroxyalkyl phosphonates (DE-A 199 27 548).

A disadvantage frequently found in the polyurethane foams known hitherto is that although the use of reactive, liquid halogen-free flame retardants achieves a high level of flame retardant action, in particular in the case of the phosphoric esters mentioned in DE-A 43 42 972 and the phosphonic esters mentioned in DE-A 199 27 548, a marked plasticizing action arises at the same time, and the resultant polyurethane foam is highly susceptible to hydrolysis, and therefore the mechanical properties of the foam have only low resistance to hydrolysis aging.

Although resistance to hydrolysis aging can be improved by using halogen-containing flame retardants, the result is then, inter alia, that the disadvantages described above for halogen-containing flame retardants have to be accepted in relation to smoke toxicity, smoke density, and formation of halogen-containing cleavage products.

It is an object of the present invention to provide a reduced-halogen-content, low-emission polyurethane foam which, when compared with a halogen-free flame-retardant polyurethane foam, has improved resistance to hydrolysis aging, and, when compared with a prior-art polyurethane foam, has lower halogen content.

The object of the invention is achieved by way of flame-retardant flexible polyurethane foams with high aging resistance, which comprise a mixture composed of hydroxyalkyl phosphonates and chlorinated phosphoric esters.

The mixture preferably comprises from 40 to 60% by weight of hydroxyalkyl phosphonates and from 60 to 40% by weight of chlorinated phosphoric esters.

With particular preference, the mixture comprises from 45 to 55% by weight of hydroxyalkyl phosphonates and from 55 to 45% by weight of chlorinated phosphoric esters.

The hydroxyalkyl phosphonates have the formula I

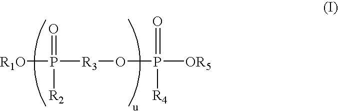

where

u denotes a chain length of from 0 to 10

R₁ and R₅ are identical or different, and are a hydroxy-containing radical of the formula II

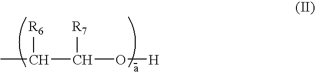

R₂ and R₄ are identical or different, and are an alkyl, aryl, or alkylaryl group having from 1 to 12 carbon atoms, and

R₃ is a radical of the formula III

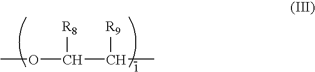

\overline{a} denotes an average chain length of from 0 to 4,

\overline{i} denotes an average chain length of from 0 to 4, and

R₆, R₇, R₈, and R₉ are identical or different and, independently of one another, are H or an alkyl group having from 1 to 6 carbon atoms.

It is preferable that u denotes a chain length of 0 or 1, \overline{a} denotes an average chain length of from 1 to 2, \overline{i} denotes an average chain length of from 1 to 2, and R₂ and R₄ are identical or different and, independently of one another, are an alkyl group having from 1 to 5 carbon atoms, and R₆, R₇, R₈, and R₉ are identical or different and, independently of one another, are H or an alkyl group having 1 or 2 carbon atoms.

The hydroxyalkyl phosphonates preferably comprise oxethylated methanephosphonic acid, oxethylated ethanephosphonic acid, propoxylated methanephosphonic acid, propoxylated ethanephosphonic acid, oxethylated propanephosphonic acid, propoxylated propanephosphonic acid, diethylene glycol bis(hydroxyalkoxy)methanephosphonate, and/or ethylene glycol bis(hydroxyalkoxy)ethanephosphonate. This aspect of the invention also includes the diesters and oligomeric diesters of ethane- or methanephosphonic acid having side chains of block copolymers composed of oxirane and methyloxirane.

The halogenated phosphoric esters preferably comprise tris(2-chloroethyl)phosphate, tris(2-chloroisopropyl)phosphate, dichloro isopropyl phosphate, trisdichloroisopropyl phosphate, and/or tetrakis(2-chloroethyl)ethylenediphosphate.

The invention also provides a process for preparing flame-retardant flexible polyurethane foams with high aging resistance, which comprises reacting organic polyisocyanates with compounds having at least two hydrogen atoms reactive toward isocyanates, with conventional blowing agents, stabilizers, activators, and/or other conventional auxiliaries and additives, in the presence of halogen-free hydroxyalkyl phosphonates of the formula I and chlorinated phosphoric esters.

It is preferable to react organic polyisocyanates with compounds having at least 2 hydrogen atoms reactive toward isocyanates, with conventional blowing agents, stabilizers, activators, and/or other conventional auxiliaries and additives, in the presence of a mixture of halogen-free hydroxyalkyl phosphonates of the formula I and chlorinated phosphoric esters.

Mixtures composed of hydroxyalkyl phosphonates of the formula I and chlorinated phosphoric esters are preferably used in an amount of from 0.01 to 50 parts by weight, based on the resultant flexible polyurethane foam.

Mixtures composed of hydroxyalkyl phosphonates of the formula I and chlorinated phosphoric esters are preferably used in an amount of from 0.5 to 20 parts by weight, based on the resultant flexible polyurethane foam.

Mixtures composed of hydroxyalkyl phosphonates of the formula I and chlorinated phosphoric esters are particularly preferably used in an amount of from 0.5 to 10 parts by weight, based on the resultant flexible polyurethane foam.

The hydroxyalkyl phosphonates of the formula I comprise compounds which are liquid at processing temperatures.

The hydroxyalkyl phosphonates of the formula I comprise compounds reactive toward isocyanates.

The production of foams based on isocyanate is known per se, and is described in DE-A 16 94 142, DE-A 16 94 215, and DE-A 17 20 768, for example.

These are mainly foams containing urethane groups and/or isocyanurate groups and/or allophanate groups and/or uretdione groups and/or urea groups and/or carbodiimide groups. The use according to the invention preferably takes place during the production of polyurethane foams and polyisocyanurate foams.

For the production of the isocyanate-based foams, use is made of the following:

Starting components: aliphatic, cycloaliphatic, araliphatic, aromatic, or heterocyclic polyisocyanates (e.g. W. Siefken in Justus Liebigs Annalen der Chemie, 562, pp. 75-136), for example those of the formula Q(NCO)ₙ, where n is from 2 to 4, preferably from 2 to 3, and Q is an aliphatic hydrocarbon radical having from 2 to 18, preferably from 6 to 10, carbon atoms, a cycloaliphatic hydrocarbon radical having from 4 to 15, preferably from 5 to 10, carbon atoms, an aromatic hydrocarbon radical having from 6 to 15, preferably from 6 to 13, carbon atoms, or an araliphatic hydrocarbon radical having from 8 to 15, preferably from 8 to 13, carbon atoms, examples being the polyisocyanates described in DE-A 28 32 253, pages 10 to 11. Particular preference is generally given to the polyisocyanates which are readily obtainable industrially and which derive from tolylene 2,4- and/or 2,6-diisocyanate or from diphenylmethane 4,4′- and/or 2,4′-diisocyanate.

Other starting components are compounds having at least two hydrogen atoms reactive toward isocyanates and having a molecular weight of from 400 to 10,000 (_{“}polyol component”). These are not only compounds having amino groups, thio groups, or carboxy groups, but preferably compounds having hydroxy groups, in particular compounds having from 2 to 8 hydroxy groups, and specifically those of molecular weight from 1000 to 6000, preferably from 200 to 6000, generally compounds having from 2 to 8, but preferably from 2 to 6, hydroxy groups, these compounds being polyethers and polyesters, or else polycarbonates and polyesteramides, as are known per se for the production of homogeneous or cellular polyurethanes, and as are described in DE-A 28 32 253, for example. The polyesters and polyethers having at least two hydroxy groups are preferred according to the invention.

Other starting components, where appropriate, are compounds having at least two hydrogen atoms reactive toward isocyanates and having a molecular weight of from 32 to 399. In this case, too, these are compounds having hydroxy groups and/or amino groups and/or thio groups and/or carboxy groups, preferably compounds having hydroxy groups and/or amino groups, these compounds serving as chainextenders or crosslinking agents. These compounds generally have from 2 to 8, preferably from 2 to 4, hydrogen atoms reactive toward isocyanates. Examples of these are described likewise in DE-A 28 32 253.

Water and/or highly volatile organic substances serve as blowing agents, examples being n-pentane, isopentane, cyclopentane, halogenated alkanes, such as trichloromethane, methylene chloride, or chlorofluoroalkanes, CO₂, and other substances.

Where appropriate, concomitant use is made of auxiliaries and additives, for example catalysts of the type known per se, surface-active additives, such as emulsifiers and foam stabilizers, retarders, e.g. acidic substances, such as hydrochloric acid or organic acid halides, or else cell regulators of the type known per se, for example paraffins or fatty alcohols, and dimethylpolysiloxanes, or else pigments or dyes, and other flame retardants of the type known per se, or else stabilizers to protect from the effects of aging and weather, plasticizers, and substances with fungistatic or bacteriostatic action, or else fillers, such as barium sulfate, Kieselguhr, carbon black, or precipitated chalk (DE-A 27 32 292).

A further overview of the raw materials, auxiliaries, and additives used for producing polyurethane foams, and the process technology for their production, is given in Kunststoff-Handbuch [Plastics Handbook], Volume VII, Carl HanserVerlag, Munich, 1993, pp.104-123.

Other examples of substances which are used concomitantly, where appropriate, according to the invention, these being surface-active additives and foam stabilizers, or else cell regulators, retarders, stabilizers, flame-retardant substances, plasticizers, dyes, and fillers, or else substances with fungistatic or bacteriostatic action, are described in Kunststoff-Handbuch [Plastics Handbook], Volume VII, Carl Hanser Verlag, Munich, 1993, pp.104-123 as are details of the method of use and the mode of action of these additives.

Method for process to produce polyurethane foams: The components for the reaction are reacted by the single-stage process known per se, the prepolymer process, or the semiprepolymer process, the machinery used frequently being, for example, that described in U.S. Pat. No. 2,764,565. Kunststoff-Handbuch [Plastics Handbook], Volume VI, Carl Hanser Verlag, Munich, 1993, pp. 139-192 describes details of other processing equipment which may be used according to the invention.

According to the invention, it is also possible to produce cold-curing foams (GB Patent 11 62 517, DE-A 21 53 086).

However, it is also possible, of course, to produce foams by slab foaming or by the twin-conveyor-belt process known per se.

Polyisocyanurate foams are produced using the processes and conditions known for that purpose.

The polyurethane plastics rendered flame-retardant according to the invention may therefore be produced in the form of elastomers by casting, or as rigid or flexible foams by a continuous or batchwise method of production, or as foamed or solid moldings.

Preference is given to flexible foams produced by a slab foaming process.

Examples of applications of the products obtainable according to the invention are: furniture padding, textile inserts, mattresses, automobile seats, armrests, and construction components, and also seat coverings and dashboard coverings.

### Substances Used

Oxethylated methanephosphonic acid OMPA (Houben-Weyl, Volume XII/1, Part 1, pp. 423-524), phosphorus content: 12.5% (w/w), acid number: <1 mg KOH/g,

hydroxy number: 440 mg KOH/g

Tetrakis(2-chloroethyl) ethylenediphosphonate (®Antiblaze V 66, Rhodia Consumer Specialities Limited)

Polyether polyol ®Desmophen PU 20 WB 05, Bayer AG, polyether polyol

Catalysts ®Niax A-1, OSi Specialties Inc., a mixture of 70% of bis(2-dimethylamino-methyl)ether and 30% of dipropylene glycol

®Dabco 33-LV, Air Products, a mixture of 67% of dipropylene glycol and 33% of diazabicyclo[2.2.2]octane

Stabilizer ®Tegostab B8232, Th. Goldschmidt AG, polyether-modified polysiloxane

Tolylene diisocyanate ®Desmodur T80, Bayer AG, a mixture of tolylene 2,4-diisocyanate and tolylene 2,6-diisocyanate

The examples below illustrate the invention:

The flame retardants described above, Antiblaze V 66, OMPA and also the inventive mixture composed of hydroxyalkyl phosphonates and chlorinated phosphoric esters (50/50), were incorporated into flexible polyurethane foams having an NCO index of 105, formulated as follows. The NCO index is a characteristic which describes the percentage ratio of the amount of isocyanate used to the stoichiometric amount, i.e. the calculated amount of isocyanate if each group reactive toward isocyanate reacts with one isocyanate group.

TABLE 1
Flexible polyurethane foam formulation

| | Example | | | | | |
|---|---|---|---|---|---|---|
| | 1 | | 2 | | 3 | |
| Polyether polyol | 100 | parts | 100 | parts | 100 | parts |
| ( ®Desmophen | | | | | | |
| PU 20 WB05) | | | | | | |
| Water | 4 | parts | 4 | parts | 4 | parts |
| Flame retardant | 12 | parts | 8 | parts | 4 | parts |
| | | V66 | | of | | of V 66/ |
| | | | | OMPA | | 4 parts |
| | | | | | | of |
| | | | | | | OMPA |
| Bis(2- | 0.1 | part | 0.1 | part | 0.1 | part |
| dimethylaminomethyl) | | | | | | |
| ether/glycol mixture | | | | | | |
| ( ®Niax A1) | | | | | | |
| Diazabicyclo[2.2.2] | 0.2 | part | 0.2 | part | 0.2 | part |
| octane/dipropylene | | | | | | |
| glycol | | | | | | |
| ( ®Dabco 33-LV) | | | | | | |
| Silicone stabilizer | 1.0 | part | 1.0 | part | 1.0 | part |
| ( ®Tegostab B 8232) | | | | | | |

| | | | |
|---|---|---|---|
| Tolylene diisocyanate | Index 105 | Index 105 | Index 105 |
| ( ®Desmodur T80) | | | |

To produce the flexible polyurethane foams of Examples 1 to 3, all of the components were intimately mixed, and the tolylene diisocyanate was incorporated last.

The flame retardancy of the flexible polyurethane foams of Examples 1 to 3 was tested by means of the FMVSS 302 Test (Federal Motor Vehicle Safety Standard).

Terminology for assessment of fire performance:

| | |
|---|---|
| SE | self-extinguishing |
| SE/NBR | self-extinguishing/no burn rate |
| SE/B | self-extinguishing/with burn rate |
| B | burn rate |

All of the products of Examples 1 to 3 achieved fire class SE.

The products from Examples 1 to 3 were aged by various methods, and compressive strength and tensile strength were determined.

Heat-aging*: 7 days at 140° C. to DIN 53578

Steam aging**: accelerated aging in a steam autoclave to DIN 53578 at 120° C. (5 hours, 3 cycles).

Compressive strength: at 40% compression to DIN 53577

Tensile strength: to DIN 53571

TABLE 2
Tensile strength (all values in N)

| | Flame | Flame | Flame |
|---|---|---|---|
| | retardant from | retardant from | retardant from |
| Tensile strength | Example 1 | Example 2 | Example 3 |
| “Starting foam” | 11.7 | 10.8 | 11.5 |
| Heat-aging* | 10 | 8 | 9.3 |
| Steam aging** | 7.4 | 4.2 | 7.2 |

TABLE 3
Compressive strength (all values in kPa)

| | Flame | Flame | Flame |
|---|---|---|---|
| | retardant from | retardant from | retardant from |
| | Example 1 | Example 2 | Example 3 |
| “Starting foam” | 5.37 | 3.41 | 5.42 |
| Heat-aging* | 5.96 | 3.79 | 6.50 |
| Steam aging** | 5.07 | 2.13 | 5.22 |

Surprisingly, it was therefore possible to show that fire class SE (FMVSS) can be achieved using amounts of 8 php with synergistic action of the mixture of the invention composed of hydroxyalkyl phosphonates and chlorinated phosphoric esters, while this would be expected only to be achievable with sole use of OMPA flame retardant, which is more effective than Antiblaze V66.

It is possible to produce flame-retardant polyurethanes with low OMPA content without giving the foams the low compressive strength and tensile strength expected when using hydroxy-containing phosphonic esters.

The flexible polyurethane foam of Example 3, rendered flame-retardant using the mixture of the invention, thus has half of the chlorine content of Example 1, with almost identical compressive strength and tensile strength and the same fire performance.

1. A flame-retardant flexible polyurethane foam with high aging resistance, which comprises a mixture composed of hydroxyalkyl phosphonates and chlorinated phosphoric esters.

2. The flame-retardant flexible polyurethane foam as claimed in claim 1, wherein the mixture comprises from 40 to 60% by weight of hydroxyalkyl phosphonates and from 60 to 40% by weight of chlorinated phosphoric esters.

3. The flame-retardant flexible polyurethane foam as claimed in claim 1 or 2, wherein the mixture comprises from 45 to 55% by weight of hydroxyalkyl phosphonates and from 55 to 45% by weight of chlorinated phosphoric esters.

4. The flame-retardant flexible polyurethane foam as claimed in one or more of claims 1 to 3, wherein the hydroxyalkyl phosphonates have the formula I 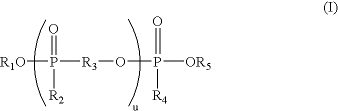
where
u denotes a chain length of from 0 to 10
R₁ and R₅ are identical or different, and are a hydroxy-containing radical of the formula II 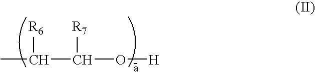
R₂ and R₄ are identical or different, and are an alkyl, aryl, or alkylaryl group having from 1 to 12 carbon atoms, and
R₃ is a radical of the formula III 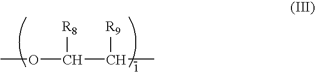
\overline{a} denotes an average chain length of from 0 to 4,
\overline{i} denotes an average chain length of from 0 to 4, and
R₆, R₇, R₈, and R₉ are identical or different and, independently of one another, are H or an alkyl group having from 1 to 6 carbon atoms.

5. The flame-retardant flexible polyurethane foam as claimed in one or more of claims 1 to 4, wherein
u denotes a chain length of 0 or 1
\overline{a} denotes an average chain length of from 1 to 2,
\overline{i} denotes an average chain length of from 1 to 2, and
R₂ and R₄ are identical or different and, independently of one another, are an alkyl group having from 1 to 5 carbon atoms, and
R₆, R₇, R₈, and R₉ are identical or different and, independently of one another, are H or an alkyl group having 1 or 2 carbon atoms.

6. The flame-retardant flexible polyurethane foam as claimed in one or more of claims 1 to 5, wherein the hydroxyalkyl phosphonates comprise oxethylated methanephosphonic acid, oxethylated ethanephosphonic acid, propoxylated methanephosphonic acid, propoxylated ethanephosphonic acid, oxethylated propanephosphonic acid, propoxylated propanephosphonic acid, diethylene glycol bis(hydroxyalkoxy)methanephosphonate, and/or ethylene glycol bis(hydroxyalkoxy)ethanephosphonate.

7. The flame-retardant flexible polyurethane foam as claimed in one or more of claims 1 to 6, wherein the halogenated phosphoric esters comprise tris(2-chloroethyl)phosphate, tris(2-chloroisopropyl)phosphate, dichloro isopropyl phosphate, trisdichloroisopropyl phosphate, and/or tetrakis(2-chloroethyl)ethylenediphosphate.

8. A process for preparing flame-retardant flexible polyurethane foams with high aging resistance, which comprises reacting organic polyisocyanates with compounds having at least two hydrogen atoms reactive toward isocyanates, with conventional blowing agents, stabilizers, activators, and/or other conventional auxiliaries and additives, in the presence of halogen-free hydroxyalkyl phosphonates of the formula I and chlorinated phosphoric esters.

9. A process for preparing flame-retardant flexible polyurethane foams with high aging resistance, which comprises reacting organic polyisocyanates with compounds having at least two hydrogen atoms reactive toward isocyanates, with conventional blowing agents, stabilizers, activators, and/or other conventional auxiliaries and additives, in the presence of a mixture of halogen-free hydroxyalkyl phosphonates of the formula I and chlorinated phosphoric esters.

10. The process as claimed in claim 8 or 9, wherein mixtures composed of hydroxyalkyl phosphonates of the formula I and chlorinated phosphoric esters are used in an amount of from 0.01 to 50 parts by weight, based on the resultant flexible polyurethane foam.

11. The process as claimed in one or more of claims 8 to 10, wherein mixtures composed of hydroxyalkyl phosphonates of the formula I and chlorinated phosphoric esters are used in an amount of from 0.5 to 20 parts by weight, based on the resultant flexible polyurethane foam.

12. The process as claimed in one or more of claims 8 to 11, wherein mixtures composed of hydroxyalkyl phosphonates of the formula I and chlorinated phosphoric esters are used in an amount of from 0.5 to 10 parts by weight, based on the resultant flexible polyurethane foam.

13. The process as claimed in one or more of claims 8 to 12, wherein the hydroxyalkyl phosphonates of the formula I comprise compounds liquid at processing temperature.

14. The process as claimed in one or more of claims 8 to 13, wherein the hydroxyalkyl phosphonates of the formula I comprise compounds reactive toward isocyanates.
